(19) United States
(12) Patent Application Publication
(10) Pub. No.: US 2009/0307359 A1
(43) Pub. Date: Dec. 10, 2009

(54) IMAGE FORMING APPARATUS, COMMUNICATION CONTROL METHOD THEREOF AND RECORDING MEDIUM

(75) Inventors: Katsuhiko AKITA, Amagasaki-shi (JP); Minako KOBAYASHI, Ikeda-shi (JP); Takehisa YAMAGUCHI, Ikoma-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/368,793

(22) Filed: Feb. 10, 2009

(30) Foreign Application Priority Data
Jun. 6, 2008 (JP) 2008-149981

(51) Int. Cl. G06F 15/173

(52) U.S. Cl. 709/228

(57) ABSTRACT

An image forming apparatus has a server cooperation function to transmit data to a data processing server connected therewith via a network and receive processed data after the server performs data processing, and is capable of communicating with a plurality of external apparatuses via the network by establishing concurrent connections. A judger judges whether or not the number of the currently established connections with the external apparatuses reaches a limit number of connections that is an allowed upper limit of concurrent connections, and a controller reserves a connection with the data processing server if the judger judges that the number of the currently established connections with the external apparatuses does not reach the limit number of connections during execution of the server cooperation function, and cancels the reserved connection with the data processing server after the end of the execution of the server cooperation function.

### THEREOF AND RECORDING MEDIUM

This application claims priority under 35 U.S.C. §119 to Japanese Patent Application No. 2008-149981 filed on Jun. 6, 2008, the entire disclosure of which is incorporated herein by reference in its entirety.

### BACKGROUND OF THE INVENTION

1. Field of the Invention

The present invention relates to an image forming apparatus such as a MFP (Multi Function Peripheral) that is a multifunctional digital machine, a communication control method of the image forming apparatus, and a computer readable recording medium having a program recorded therein to make a computer of the image forming apparatus execute processing.

2. Description of the Related Art

The following description sets forth the inventor's knowledge of related art and problems therein and should not be construed as an admission of knowledge in the prior art.

Recently, image forming apparatuses of a certain kind, such as MFPs, are known for their own functions to cooperate with a server connected therewith via a network. By executing a server cooperation function, such an image forming apparatus transmits data to a server having an application to perform in a predetermined manner, data processing that the image forming apparatus is not capable of, and makes the server perform data processing, and after that, receives processed data from the server.

However, it is a disadvantage of server cooperation functions that it sometimes takes a long time for the server to perform data processing.

When it takes a long time, the image forming apparatus temporarily terminates the connection with the server after transmitting data to the server and the server transmits a connection request again to the image forming apparatus after data processing. This is necessary for the image forming apparatus to receive data from the server.

Conventionally, there is a technology disclosed (for example, in Japanese Unexamined Laid-open Patent Publication No. 2004-264994) to establish short connections at time intervals, which could eliminate the inconvenience that the connections to a server, which are regularly established by a large number of MFPs, exceed a processing capacity of the server or a circuit capacity.

Furthermore, there is another technology disclosed (for example, in Japanese Unexamined Laid-open Patent Publication No. 2006-092419) to adjust the timings for establishment of connections with a printer or etc., by using random numbers.

However, the method in which the image forming apparatus temporarily terminates the connection with the server after transmitting data to the server and the server transmits a connection request again to the image forming apparatus after data processing, during execution of a server cooperation function, still leaves some problems as the following.

That is, some of the conventional images forming apparatuses such as MFPs are capable of communicating with a plurality of external apparatuses via a network by establishing concurrent connections. However, if the number of the currently established connections between such an image forming apparatus and external apparatuses reaches an allowable upper limit of concurrent connections, the image forming apparatus cannot process a connection request received from the server, and needs to wait to receive processed data from the server until any of the currently established connections is terminated. In this case, there is a problem that it takes a long time until the end of execution of a server cooperation function. Furthermore, as long as the image forming apparatus does not establish a connection with the server in response to a connection request received from the server, the server needs to repeatedly transmit a connection request to the image forming apparatus. In this case, there is a possible problem that a timeout occurs after a predetermined number of connection requests and a job executed by executing a server cooperation function is forcibly terminated due to an error.

The technologies disclosed in the patent publications 1 and 2 do not bring practical solutions on the problems described above.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an objective of the present invention to provide an image forming apparatus that is capable of shortening the time required from the start until the end of execution of a server cooperation function, by eliminating the inconvenience arising during the execution of the server cooperation function, that the image forming apparatus needs to wait to receive processed data from a data processing server, if the image forming apparatus temporarily terminates a connection with the server after transmitting data to the server and receives a connection request from the server after the server performs data processing and the number of the currently established connections with external apparatuses reaches an allowable upper limit of concurrent connections.

It is another objective of the present invention to provide a communication control method of the image forming apparatus, which is capable of shortening the time required from the start until the end of execution of a server cooperation function, by eliminating the inconvenience arising during the execution of the server cooperation function, that the image forming apparatus needs to wait to receive processed data from a data processing server, if the image forming apparatus temporarily terminates a connection with the server after transmitting data to the server and receives a connection request from the server after the server performs data processing and the number of the currently established connections with external apparatuses reaches an allowable upper limit of concurrent connections.

It is yet another objective of the present invention to provide a computer readable recording medium having a communication control program recorded therein to make a computer of the image forming apparatus execute processing by the communication control method.

According to a first aspect of the present invention, an image forming apparatus has a server cooperation function to transmit data to a data processing server connected therewith via a network and receive processed data after the server performs data processing, and is capable of communicating with a plurality of external apparatuses via the network by establishing concurrent connections, and comprises:
a judger that judges whether or not the number of the currently established connections with the external apparatuses reaches a limit number of connections that is an allowable upper limit of concurrent connections, during execution of the server cooperation function; and
a controller that reserves a connection with the server if the judger judges that the number of the currently established connections does not reach the limit number of connections, and cancels the reserved connection after the end of the execution of the server cooperation function.

According to a second aspect of the present invention, an image forming apparatus has a server cooperation function to transmit data to a data processing server connected therewith via a network and receive processed data after the server performs data processing, and is capable of communicating with a plurality of external apparatuses via the network by establishing concurrent connections, and comprises:
a detector that detects a connection request that is transmitted by the server in order to transmit the processed data subsequently;
a judger that judges whether or not the number of the currently established connections with the external apparatuses reaches a limit number of connections that is an allowed upper limit of concurrent connections; and
a controller that terminates any of the currently established connections, if the detector detects a connection request from the server and the judger judges that the number of the currently established connections reaches the limit number of connections.

According to a third aspect of the present invention, a communication control method of an image forming apparatus that has a server cooperation function to transmit data to a data processing server connected therewith via a network and receive processed data after the server performs data processing, and is capable of communicating with a plurality of external apparatuses via the network by establishing concurrent connections, comprises:
judging whether or not the number of the currently established connections with the external apparatuses reaches a limit number of connections that is an allowable upper limit of concurrent connections, during execution of the server cooperation function; and
reserving a connection with the server if it is judged in the judgment step that the number of the currently established connections does not reach the limit number of connections, and cancelling the reserved connection after the end of the execution of the server cooperation function.

According to a fourth aspect of the present invention, a communication control method of an image forming apparatus that has a server cooperation function to transmit data to a data processing server connected therewith via a network and receive processed data after the server performs data processing, and is capable of communicating with a plurality of external apparatuses via the network by establishing concurrent connections, comprises:
detecting a connection request that is transmitted by the server in order to transmit the processed data subsequently;
judging whether or not the number of the currently established connections with the external apparatuses reaches a limit number of connections that is an allowable upper limit of concurrent connections;
terminating any of the currently established connections, if a connection request from the server is detected in the detection step and it is judged in the judgment step that the number of the currently established connections reaches the limit number of connections.

According to a fifth aspect of the present invention, a computer readable recording medium has a communication control program recorded therein to make a computer of an image forming apparatus that has a server cooperation function to transmit data to a data processing server connected therewith via a network and receive processed data after the server performs data processing, and is capable of communicating with a plurality of external apparatuses via the network by establishing concurrent connections, execute:
judging whether or not the number of the currently established connections with the external apparatuses reaches a limit number of connections that is an allowable upper limit of concurrent connections, during execution of the server cooperation function; and
reserving a connection with the server if it is judged in the judgment step that the number of the currently established connections does not reach the limit number of connections, and cancelling the reserved connection after the end of the execution of the server cooperation function.

According to a sixth aspect of the present invention, a computer readable recording medium has a communication control program recorded therein to make a computer of an image forming apparatus that has a server cooperation function to transmit data to a data processing server connected therewith via a network and receive processed data after the server performs data processing, and is capable of communicating with a plurality of external apparatuses via the network by establishing concurrent connections, execute:
detecting a connection request that is transmitted by the server in order to transmit the processed data subsequently;
judging whether or not the number of the currently established connections with the external apparatuses reaches a limit number of connections that is an allowable upper limit of concurrent connections; and
terminating any of the currently established connections, if a connection request from the server is detected in the detection step and it is judged in the judgment step that the number of the currently established connections reaches the limit number of connections.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view schematically showing a configuration of a server cooperation system employing an image forming apparatus according to one embodiment of the present invention;

FIG. 2 is a block diagram showing a functional configuration of the image forming apparatus;

FIG. 3 is a plain view showing an operation panel of the image forming apparatus;

FIG. 4 is a flowchart representing a procedure executed in the image forming apparatus when a server cooperation function is executed;

FIG. 5 shows an example of a server cooperation function execution table;

FIG. 6 is a flowchart representing a procedure executed in the image forming apparatus when a server cooperation function is executed, according to another embodiment of the present invention;

FIG. 7 is a flowchart representing a procedure executed in the image forming apparatus when a server cooperation function is executed, according to yet another embodiment of the present invention;

FIG. 8 is a flowchart representing a procedure executed in the image forming apparatus when a server cooperation function is executed, according to still yet another embodiment of the present invention;

FIG. 9 shows an example of the server cooperation function execution table that is used when the procedure represented by the flowchart of FIG. 8 is executed in the image forming apparatus;

FIG. 10 is a flowchart representing a procedure executed in the image forming apparatus when a server cooperation function is executed, according to further still yet another embodiment of the present invention;

FIG. 11 shows an example of the server cooperation function execution table that is used when the procedure represented by the flowchart of FIG. 10 is executed in the image forming apparatus;

FIG. 12 shows an example of the connection administration table that is used when the procedure represented by the flowchart of FIG. 10 is executed in the image forming apparatus;

FIG. 13 is a flowchart representing a procedure executed in the image forming apparatus when a server cooperation function is executed, according to further still yet another embodiment of the present invention;

FIG. 14 shows an example of the connection administration table that is used when the procedure represented by the flowchart of FIG. 13 is executed in the image forming apparatus;

FIG. 15 is a flowchart representing a procedure executed in the image forming apparatus when a server cooperation function is executed, according to further still yet another embodiment of the present invention; and

FIG. 16 shows an example of the connection administration table that is used when the procedure represented by the flowchart of FIG. 15 is executed in the image forming apparatus.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

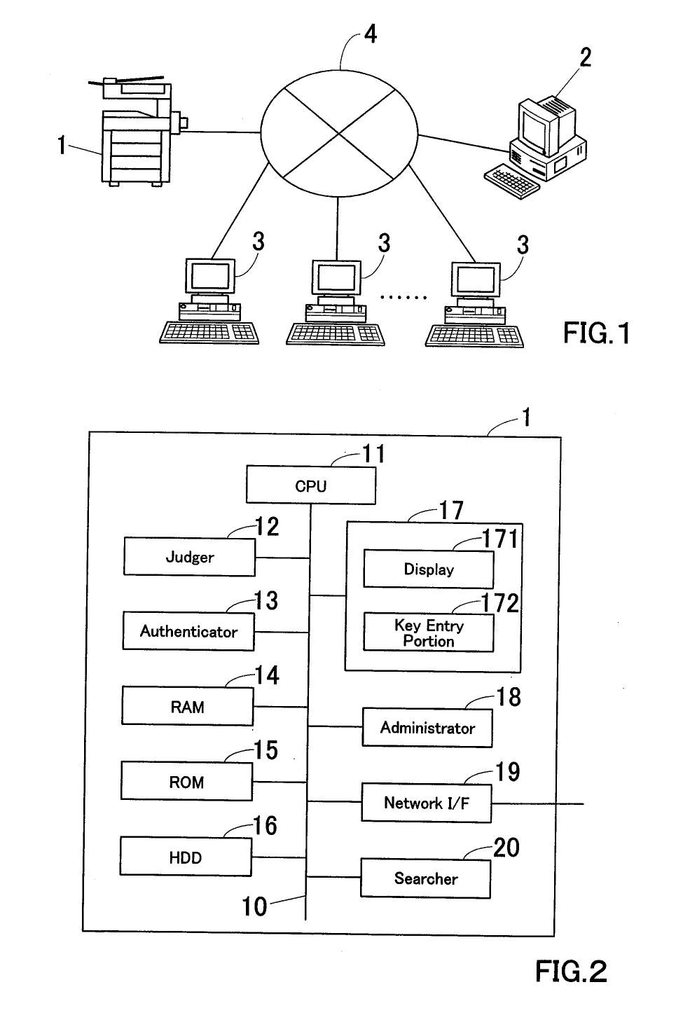

FIG. 1 is a view schematically showing a configuration of a server cooperation system employing an image forming apparatus according to one embodiment of the present invention.

As shown in FIG. 1, this server cooperation system comprises an image forming apparatus 1, a server 2 and a plurality of personal computers (hereinafter, will be referred to as “PCs”) 3 as user terminals. And the image forming apparatus 1, the server 2 and the PCs 3 are interconnected via a network 4.

In this embodiment, a MFP that is a multifunctional digital machine having a plurality of functions such as the copy function, the print functions and the facsimile function as described above, is employed as the image forming apparatus 1. This image forming apparatus 1 has server cooperation functions to transmit data to the data processing server 2 and receive processed data from the server 2 after the server 2 performs data processing. Furthermore, the image forming apparatus 1 is capable of communicating with a plurality of external apparatuses such as PCs 3 via the network 4 by concurrent connections, but cannot establish more connections than a limit number of connections that is an allowable upper limit of concurrent connections, set in advance. Regarding the meaning of “connection” in this case, establishment of a “connection” (hereinafter, will be also referred to as “real connection”) brings a capable state to perform data communication, on the other hand, there is no limit on the number of “connections” to examine if establishment of a real connection would be permitted/prohibited (hereinafter, will be also referred to as “trial connections”).

FIG. 2 is a block diagram showing a functional configuration of the image forming apparatus 1.

As shown in FIG. 2, this image forming apparatus 1 comprises a CPU 11, a judger 12, an authenticator 13, a RAM 14, a ROM 15, a hard disk drive (HDD) 16, an operation panel 17, an administrator 18, a network interface (network I/F) 19, a searcher 20 and etc. interconnected via a bus line 10.

The CPU 11 centrally controls all the operations performed in the image forming apparatus 1, and executes various functions of the image forming apparatus 1, such as the copy function, the print function and the facsimile function. Furthermore, in this embodiment, it controls operations to execute server cooperation functions. Detailed explanation thereof will be provided later.

When a server cooperation function is executed, the judger 12 judges whether or not the number of the currently established connections with external apparatuses such as the PCs 3 reaches a limit number of connections that is an allowable upper limit of concurrent connections as describe above, based on a result of comparison between the number of the currently established connections and the limit number of connections.

The authenticator 13 performs authentication to judge whether or not to permit a user trying to log in the image forming apparatus to perform operations. Instead thereof, an authentication server or etc. may perform authentication by the external authentication method.

The RAM 14 is a memory that provides an operation area for the CPU 11 to execute processing according to an operation program. The ROM 15 is a memory that stores in itself an operation program for the CPU 11 and other data.

The HDD 16 records in itself various kinds of data, programs and etc. In this embodiment, when a server cooperation function is executed, it records a server cooperation function execution table, in which an address of the cooperation server 2, an ID of the job, according to which the server 2 performs data processing, and also, if needed, a user and other information, are interrelated. In addition, it also records a connection administration table, in which addresses of the currently connecting external apparatuses, information indicating whether or not the external apparatuses correspond to servers supposed to perform data processing by executing a server cooperation function, and also, if needed, user names, states of connection, connection times and other information, are interrelated.

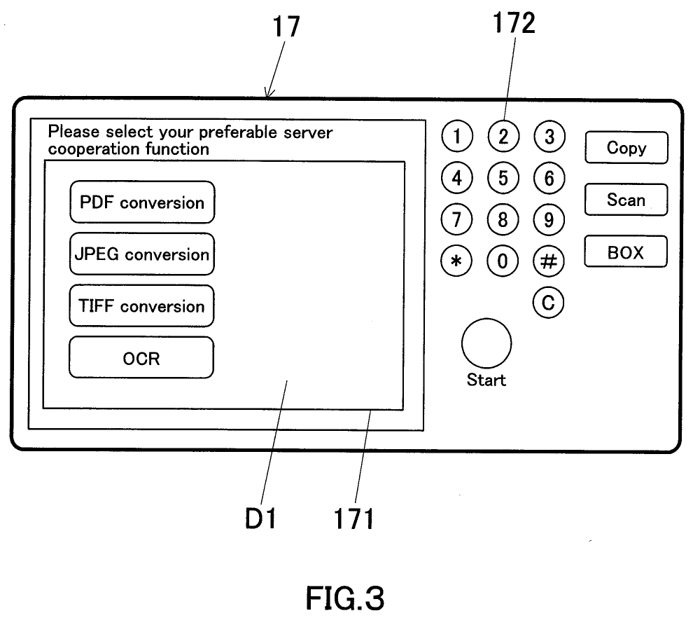

The operation panel 17 is used to select among various functions including server cooperation functions and enter a user name, a password and etc. It comprises a display 171 and a key entry portion 172. The display 171 is a liquid crystal display with touch-panel functionality for example, and is capable of displaying on itself various operation screens including a server cooperation function selection screen D1 shown in FIG. 3, entered information such as a user name and a password, an operation result and etc. The key entry portion 172 comprises numeric keys, a start key and other keys.

The administrator 18 administers the server cooperation function execution table, the connection administration table, the number of the currently established connections, the number of the currently reserved connections with the cooperation server, and etc.

The network interface (I/F) 19 functions as a communicator that performs data communication with the server 2, the PCs 3 and etc. on the network 4.

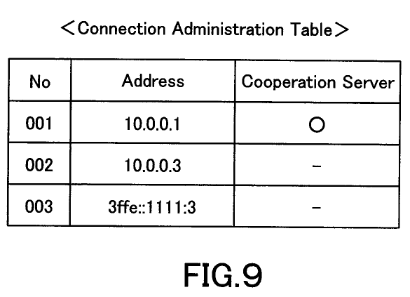

The searcher 20 searches through the server cooperation function execution table shown in FIG. 5, the connection administration table shown in FIG. 9 and etc., to identify a prescribed search target.

The functions of the judger 12, the authenticator 13, the administrator 18, the searcher 20 and etc. are executed by the CPU 11 according to an operation program.

The server 2 performs processes such as a PDF (Portable Document Format) conversion, a JPEG (Joint Photographic Experts Group) conversion, a TIFF (Tagged Image File Format) conversion and an OCR (Optical Character Recognition), and comprises a computer having applications installed thereon to execute these processes.

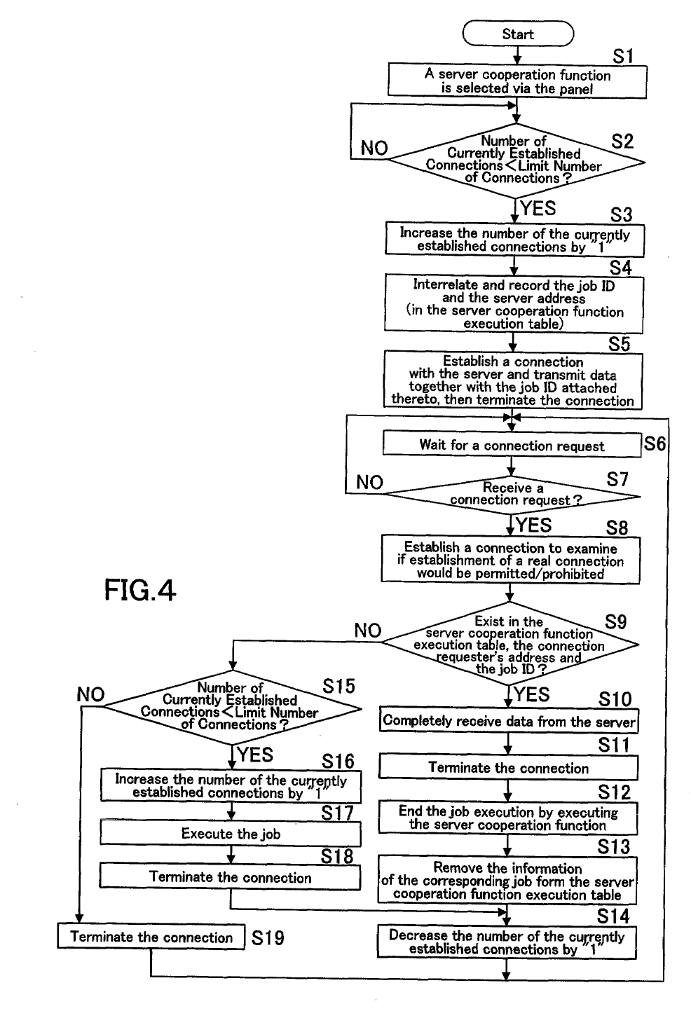

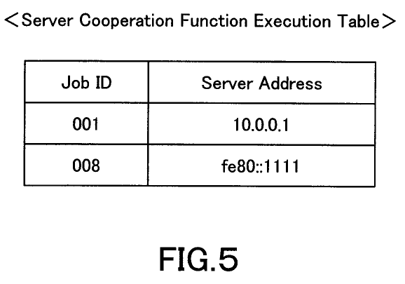

Hereinafter, a procedure executed in the image forming apparatus 1 when a user performs an operation to use a server cooperation function of the image forming apparatus 1, will be explained with reference to FIG. 3 and FIG. 4.

A user performs an operation via the operation panel 17 of the image forming apparatus 1. As shown in FIG. 3, a server cooperation function selection screen D1 to select among the four functions “PDF conversion”, “JPEG conversion”, “TIFF conversion” and “OCR”, for example, is displayed on the display 171 of the operation panel 17. When a user selects any of the functions and presses a start button, data processing is started.

FIG. 4 is flowchart representing a procedure executed in the image forming apparatus 1. This procedure is executed by the CPU 11 according to a program stored in the ROM 15 or etc.

A user selects any of the functions and presses the start button via the server cooperation function selection screen shown in FIG. 3. This selection is accepted in Step S1, and it is judged in Step S2, whether or not the number of the currently established connections between the image forming apparatus 1 and external apparatuses such as the PCs 3 and servers (the number of real connections) reaches the limit number of connections. If the number of the currently established connections reaches the limit number of connections (NO in Step S2), the routine waits until the number of the currently established connections becomes smaller than the limit number of connections. In this case, a screen warning of a server connection failure may be displayed on the display 171 of the operation panel 17. Alternatively, any of the currently established connections may be forcibly terminated according to a user instruction.

If the number of the currently established connections does not reach the limit number of connections (YES in Step S2), the number of the currently established connections is increased by “1” in Step S3, and thus a connection with the server 2 is reserved. Then the routine proceeds to Step S4.

In Step S4, an ID of the job, according to which the server 2 performs data processing, and an address of the server 2 are interrelated and recorded in the server cooperation function execution table shown in FIG. 5. Then in Step S5, a connection with the server 2 is established and data is transmitted to the server 2 together with the job ID attached thereto, then the connection with the server 2 is terminated

Receiving the data, the server 2 performs data processing in a predetermined manner. After the data processing, in order to return processed data, the server 2 transmits a connection request to the image forming apparatus 1.

In Step S6, the routine waits until a connection request is received, and it is judged in Step S7, whether or not a connection request is received. If no connection request is received (NO in Step S7), the routine goes back to Step S6 and waits until a connection request is received. If a connection request is received (YES in Step S7), in order to obtain the connection requester's address and the job ID, a connection (trial connection) to examine if establishment of a real connection would be permitted/prohibited, is established in Step S8. Then the routine proceeds to Step S9.

In Step S9, it is judged whether or not there exist in the server cooperation function execution table (FIG. 5), the connection requester's address and the job ID. If there does not exist in the server cooperation function execution table, the connection requester's address and the job ID (NO in Step S9), the routine proceeds to Step S15. In this case, the connection request was likely received from any of the PCs 3 requesting to perform a print operation, for example, not from the server 2 requesting to establish a connection by executing a server cooperation function.

If there exist in the server cooperation function execution table, the connection requester's address and the job ID (YES in Step S9), since a connection with the server 2 has been reserved, a connection with the server 2 is immediately established and data is completely received from the server 2, in Step S10.

Then, the connection is terminated in Step S11, and the job execution by executing the server cooperation function is ended in Step S12, and then the information (the job ID and the server address) of the corresponding job is removed from the server cooperation function execution table, in Step S13. And in Step S14, the number of the currently established connections is decreased by “1”, and thus the connection with the server 2, reserved in Step S3, is cancelled. Then the routine goes back to Step S6.

In Step S9, if there do not exist in the server cooperation function execution table shown in FIG. 5, the connection requester's address and the job ID (NO in Step S9), then it is judged in Step S15, whether or not the number of the currently established connections with external apparatuses reaches the limit number of connections. If the number of the currently established connections reaches the limit number of connections (NO in Step S15), the routine proceeds to Step S19, in which the connection (trial connection) is terminated. Then the routine goes back to Step S6.

If the number of the currently established connections does not reach the limit number of connections (YES in Step S15), the number of the currently established connections is increased by “1” in Step S16, and a job received from the PC 3, such as a print job, is executed in Step S17. Then the connection is terminated in Step S18. Subsequently, the routine proceeds to Step S14, in which the number of the currently established connections is decreased by “1”. Then the routine goes back to Step S6.

As described above in this embodiment, if the number of the currently established connections does not reach the limit number of connections during execution of a server cooperation function, a connection with the cooperation server 2 is reserved in advance, and the reserved connection with the cooperation server 2 is cancelled after the end of the execution of a server cooperation function. Since the reserved connection with the server 2 ensures that processed data is received from the server 2, processed data is received from the server 2 without waiting so long. This would eliminate the inconvenience that processed data is not received from the server 2 if the number of the currently established connections reaches the limit number of connections, and thereby the time required from the start until the end of execution of a server cooperation function can be shortened.

Furthermore, by using a job ID and a server address, the processed data is correctly identified whether or not as being received from a certain server that is instructed to perform data processing by executing a server cooperation function. Thus, the processed data can be received unfailingly from the server 2.

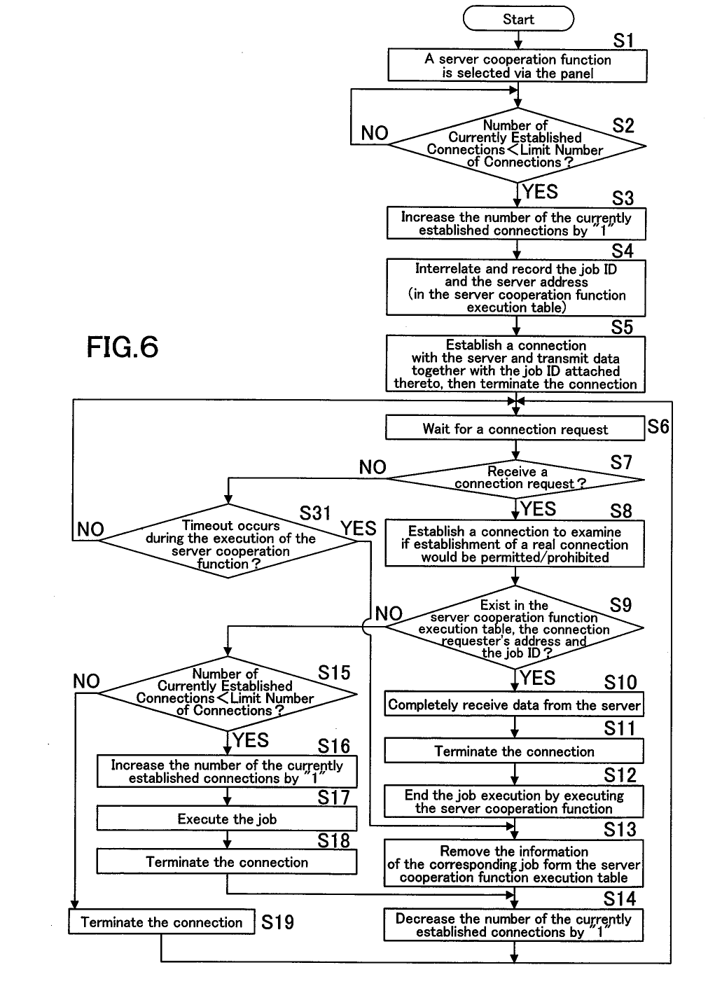

Hereinafter, another embodiment of the present invention will be explained with reference to a flowchart shown in FIG. 6.

In this embodiment, the reserved connection with the server 2 is cancelled if execution of a server cooperation function is not ended due to no connection request having been received from the server 2 within a predetermined period of time after the start of the execution of a server cooperation function. This would eliminate the inconvenience that it takes a long time for the server to perform data processing, due to a trouble or etc. for example.

Here, explanation about some of the Steps of the flowchart shown in FIG. 6, having the same Step numbers as those in the flowchart shown in FIG. 4, is omitted.

As shown in FIG. 6, if no connection request is received (NO in Step S7), then it is judged in Step S31, whether or not a timeout occurs during the execution of the server cooperation function. If no timeout occurs (NO in Step S31), the routine goes back to Step S6 and waits until a connection request is received. If a timeout occurs (YES in Step S31), the routine proceeds to Step S13, in Which the information (the job ID and the server address) of the corresponding job information is removed from the server cooperation function execution table. Then in Step S14, the number of the currently established connections is decreased by “1”, and thus the reserved connection with the server 2 is cancelled.

As described above in this embodiment, if execution of a server cooperation function is not ended within a predetermined period of time after the start of the execution of a server cooperation function, the reserved connection with the server 2 is canceled. This would eliminate the inconvenience that a reserved connection with the server is still kept and another connection with an external apparatus is prevented from being established for a long time.

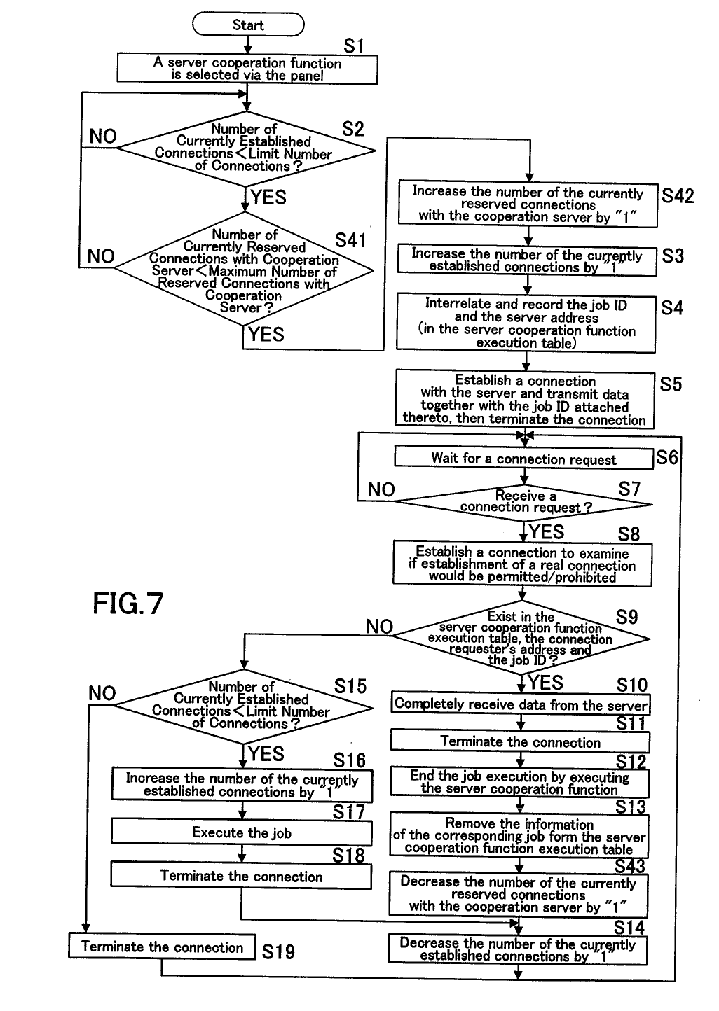

Hereinafter, yet another embodiment of the present invention will be explained with reference to a flowchart shown in FIG. 7.

In this embodiment, the maximum value of reserved connections with the cooperation server (also referred to as “the maximum number of reserved connections) is set to a value smaller than the limit number of connections.

Here, explanation about some of the Steps of the flowchart shown in FIG. 7, having the same Step numbers as those in the flowchart shown in FIG. 4, is omitted.

In Step S2, if the number of the currently established connections does not reach the limit number of connections (YES in Step S2), then it is judged in Step S41, whether or not the number of the currently reserved connections with the cooperation server reaches the maximum number of reserved connections.

If the number of the currently reserved connections with the cooperation server does not reach the maximum number of reserved connections (YES in Step S41), the number of the currently reserved connections with the cooperation server is increased by “1”. Then the routine proceeds to Step S3. If the number of the currently reserved connections with the cooperation server reaches the maximum number of reserved connections (NO in Step S41), the routine goes back to Step S2.

In Step S13, the information of the corresponding job is removed from the server cooperation function execution table. After that, the number of the currently reserved connections with the cooperation server is decreased by “1” in Step S43, and the routine proceeds to Step S14, in which the number of the currently established connections is decreased by “1”.

As described above in this embodiment, the maximum number of reserved connections with the server 2 that is supposed to perform data processing by executing a server cooperation function, is set to a value smaller than the limit number of connections. This would unfailingly eliminate the inconvenience that data communications other than that performed by executing a server cooperation function are disabled, if the connections as many as the limit number of connections have been reserved for data communications performed by executing a server cooperation function.

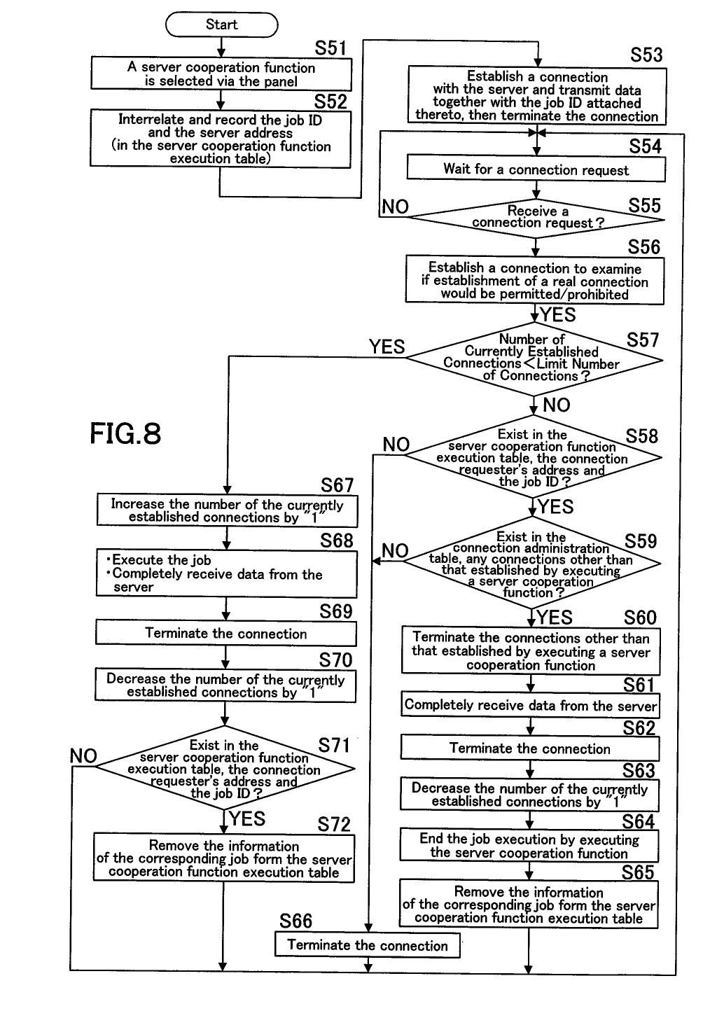

Hereinafter, still yet another embodiment of the present invention will be explained with reference to a flowchart shown in FIG. 8.

In this embodiment, any of the currently established connections with external apparatuses is terminated, if the server 2 transmits a connection request to the image forming apparatus 1 after image data processing and the number of the currently established connections reaches the limit number of connections, during execution of a server cooperation function is executed.

The procedure shown in FIG. 8 is also executed by the CPU 11 according to a program stored in the ROM 15 or etc.

A user selects any of the functions and presses the start button via the server cooperation function selection screen shown in FIG. 3. This selection is accepted in Step S51, and then in Step S52, an ID of the job, according to which the server 2 performs data processing, and an address of the server 2 are interrelated and recorded in the server cooperation function execution table shown in FIG. 5.

And then in Step S53, a connection with the server 2 is established and data is transmitted to the server 2 together with the job ID attached thereto, then the connection with the server 2 is terminated.

Receiving the data, the server 2 performs data processing in a predetermined manner. After the data processing, in order to return processed data, the server 2 transmits a connection request to the image forming apparatus 1.

In Step S54, the routine waits until a connection request is received, and it is judged in Step S55, whether or not a connection request is received. If no connection request is received (NO in Step S55), the routine goes back to Step S54 and waits until a connection request is received. If a connection request is received (YES in Step S55), in order to obtain the connection requester server 2's address and the job ID, a connection (trial connection) to examine if establishment of a real connection would be permitted/prohibited, is established in Step S56. Then the routine proceeds to Step S57.

In Step S57, it is judged whether or not the number of the currently established connections reaches the limit number of connections. If the number of the currently established connections reaches the limit number of connections (NO in Step S57), the routine proceeds to Step S58, meanwhile if the number of the currently established connections does not reach the limit number of connections (YES in Step S57), the routine proceeds to Step S67.

In Step S58, it is judged whether or not there exist in the server cooperation function execution table (FIG. 5), the connection requester's address and the job ID. If there do not exist in the server cooperation function execution table, the connection requester's address and the job ID (NO in Step S58), since the connection request was not likely received from the server 2 by executing a server cooperation function, the connection (trial connection) is terminated in Step S66. Then the routine goes back to Step S54.

If there exist in the server cooperation function execution table, the connection requester's address and the job ID (YES in Step S58), since the connection request was likely received from the server 2 by executing a server cooperation function, then it is judged in Step S59, whether or not there exist in the connection administration table shown in FIG. 6, any connections (real connections) other than that established by executing a server cooperation function.

The connection administration table shown in FIG. 9 records destination apparatuses' addresses and information indicating whether or not the apparatuses correspond to servers that established the connections by executing a server cooperation function, and these information are interrelated. According to this example of FIG. 9, the connections No. 002 and 003 are other than that established by executing a server cooperation function.

If there exist in the connection administration table, no connections other than that established by executing a server cooperation function (NO in Step S59), in other words, all of the currently established connections are those established by executing a server cooperation function, the connection (trial connection) with the server 2 that transmitted a connection request is terminated in Step S66. Then the routine goes back to Step S54. If there exist in the connection administration table shown in FIG. 9, any connections other than that established by executing a server cooperation function (YES in Step S59), any of the connections other than that established by executing a server cooperation function is terminated in Step S60.

Then in Step S61, a connection with the server 2 that transmitted a connection request is established and data is received therefrom. And the connection with the server 2 is terminated in Step S62.

Subsequently, the number of the currently established connections is decreased by “1” in Step S63, and the job execution by executing the server cooperation function is ended in Step S64, and then the information of the corresponding job is removed from the sever cooperation function execution table, in Step S65. Then the routine goes back to Step S54.

In Step S57, if the number of the currently established connections does not reach the limit number of connections (YES in Step S57), the number of the currently established connections is increased by “1” in Step S67, and thus a connection with the connection requester apparatus can be established. Then in Step S68, the job is executed if the connection requester corresponds to any of the PCs 3 or etc., meanwhile data is completely received from the server 2 if the connection requester corresponds to the server 2 that performed data processing by executing the server cooperation function.

After that, the connection (real connection) is terminated in Step S69, and the number of the currently established connections is decreased by “1” in Step S70. Then the routine proceeds to Step S71.

In Step S71, it is judged whether or not there exist in the server cooperation function execution table, the connection requester's address and the job ID. If there do not exist in the server cooperation function execution table, the connection requester's address and the job ID (NO in Step S71), the routine directly goes back to Step S54. If there exist in the server cooperation function execution table, the connection requester's address and the job ID (YES in Step S71), the information of the corresponding job is removed from the server cooperation function execution table in Step S72. Then the routine goes back to Step S54.

As described above in this embodiment, any of the currently established connections with external apparatuses is terminated, if a connection request is received from the server 2 having the intention to provide processed data and it is judged that the number of the currently established connections reaches the limit number of connections. And thus, a connection with the server 2 that transmitted a connection request can be established and processed data can be received therefrom, smoothly. This would eliminate the inconvenience that the image forming apparatus 1 needs to wait to receive processed data from the server 2, if the number of the currently established connections reaches the limit number of connections, and thereby the time required from the start until the end of execution of a server cooperation function can be shortened.

As for the connection forcibly terminating process in Step S60 of the flowchart shown in FIG. 8, the connection forcibly terminated in this process is not limited to a specific type. Although, for example, if a user who instructed to execute a server cooperation function performs data communication with an external apparatus, this user's established connection may be preferentially terminated. This would eliminate another user's inconvenience caused due to forcibly termination of this other user's established connection.

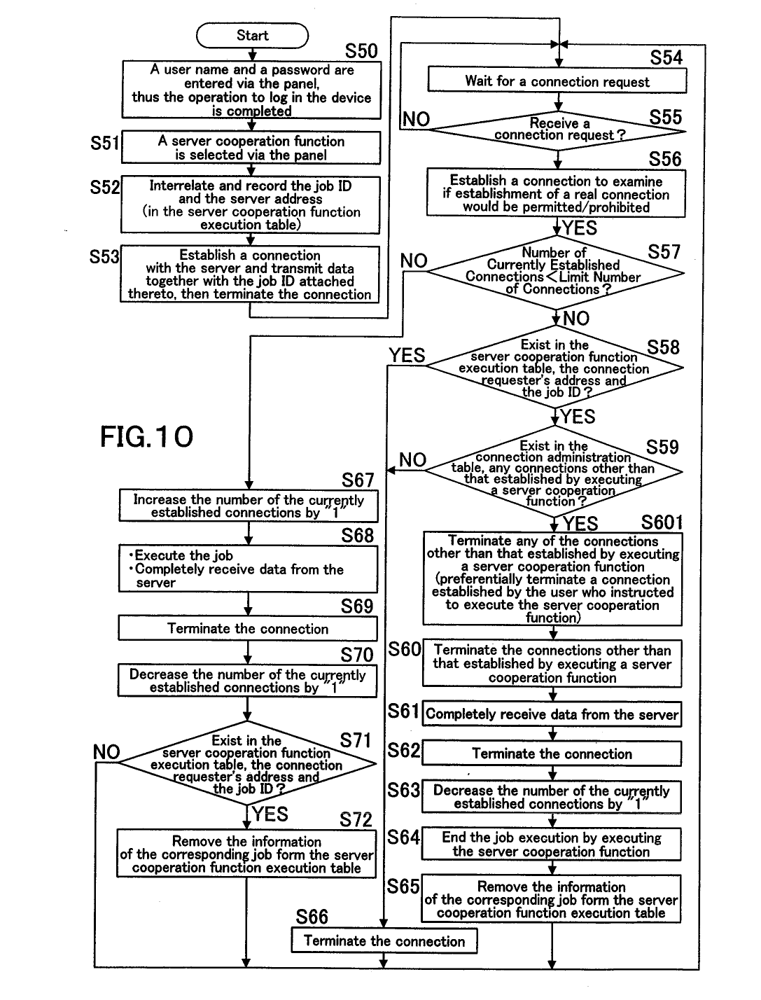

FIG. 10 is a flowchart representing a procedure that is executed to terminate preferentially a connection established by a user who instructed to execute a server cooperation function, if this user performs data communication with an external apparatus. Here, explanation about some of the Steps of the flowchart shown in FIG. 10, having the same Step numbers as those in the flowchart shown in FIG. 8, is omitted.

A user enters a user name and a password via the operation panel 17 of the image forming apparatus 1. This entry is accepted in Step S50, thus he/she completes logging in the image forming apparatus 1.

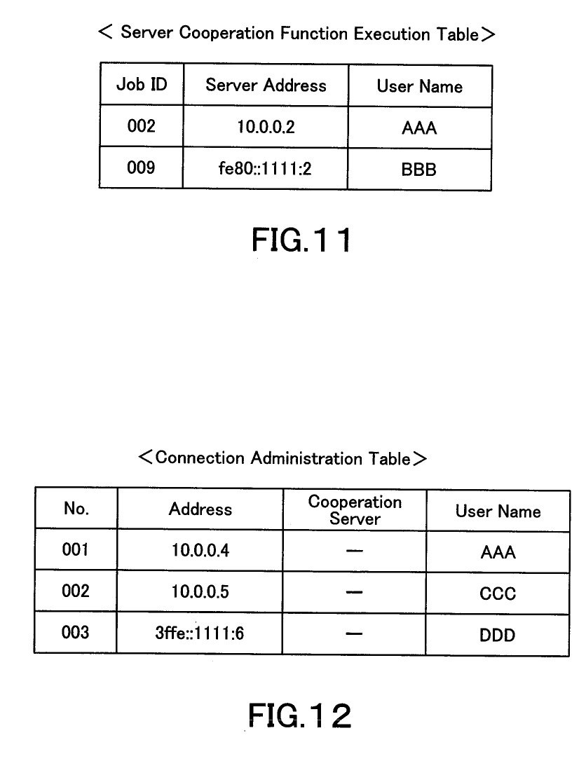

Then, the user selects any of the functions and presses the start button via the server cooperation function selection screen shown in FIG. 3. This selection is accepted in Step S51, and then in Step S52, an ID of the job, according to which the server 2 performs data processing, an address of the server 2 and the user name are interrelated and recorded in the server cooperation function execution table shown in FIG. 11.

In Step S58, it is judged whether or not there exist in the server cooperation function execution table shown in FIG. 11, the connection requester's address and the job ID. If there exist in the server cooperation function execution table, the connection requester's address and the job ID (YES in Step S58), then it is judged in Step S59, whether or not there exist in the connection administration table shown in FIG. 12, any connections other than that established by executing a server cooperation function.

The connection administration table shown in FIG. 12 records destination apparatuses' addresses, information indicating whether or not the apparatuses correspond to servers that established the connections by executing a server cooperation function and a user name, and these information are interrelated. According to this example of FIG. 12, the connections No. 001 (user name: AAA), No. 002 (user name: CCC) and No. 003 (user name: DDD) are other than that established by executing a server cooperation function, and the connection No. 001 is established by a user who instructed to execute the sever cooperation function.

If there exist in the connection administration table, any connections other than that established by executing a server cooperation function (YES in Step S59), then in Step S601, any of the connections other than that established by executing a server cooperation function is terminated, and specifically among those, a connection established by the user who instructed to execute the server cooperation function is preferentially terminated. In this example, the connection No. 001 is preferentially terminated.

The connection forcibly terminated in this procedure may be idle (not used for data communication). Termination of an idle connection would eliminate the inconvenience that data communication is stopped halfway.

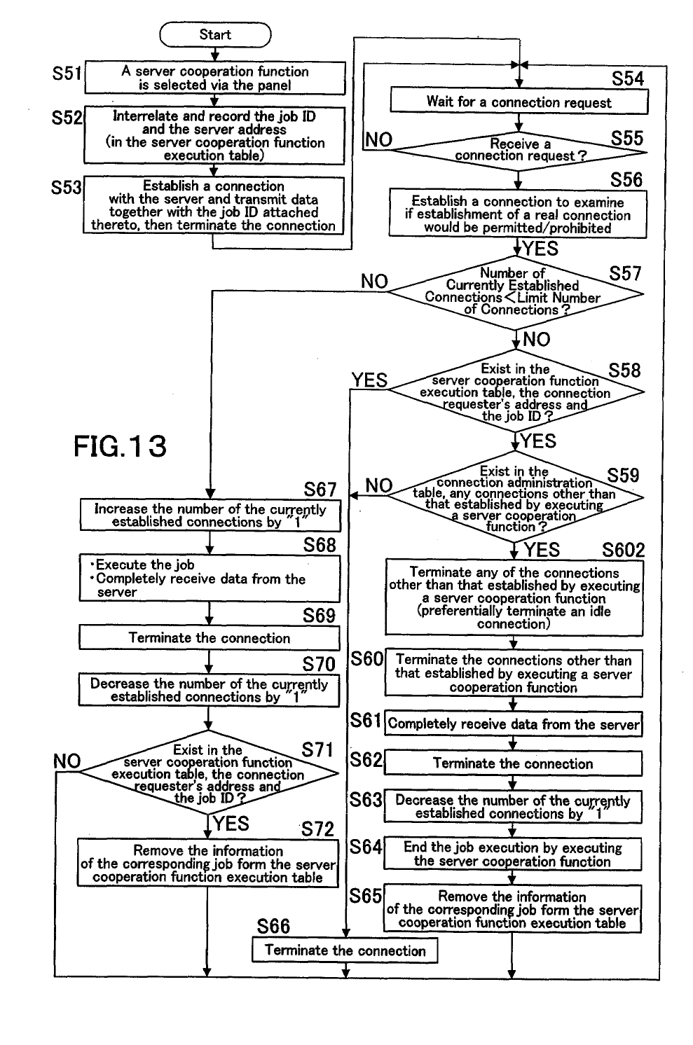

FIG. 13 is a flowchart representing a procedure executed by executing a server cooperation function, to preferentially terminate an idle connection if a connection request is received from the server 2 and the number of the concurrent connections owned by the image forming apparatus 1 reaches the limit number of connections. Here, explanation about some of the Steps of this flowchart, having the same Step numbers as those in FIG. 8, is omitted.

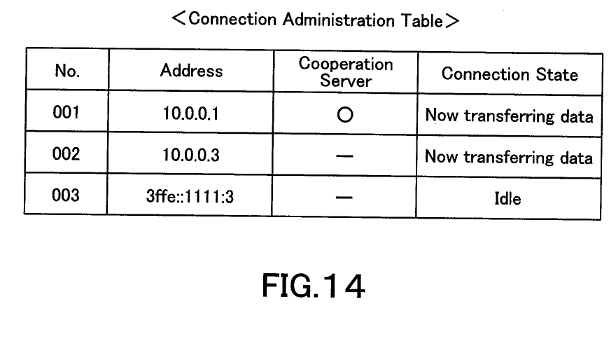

In Step S58, it is judged whether or not there exist in the server cooperation function execution table shown in FIG. 5, the connection requester's address and the job ID. If there exist in the server cooperation function execution table, the connection requester's address and the job ID (YES in Step S58), then it is judged in Step S59, whether or not there exist in the connection administration table shown in FIG. 14, any connections other than that established by executing a server cooperation function.

The connection administration table shown in FIG. 14 records destination apparatuses' addresses, information indicating whether or not the apparatuses correspond to servers that established the connections by executing a server cooperation function, and current states of the connections (now transferring data or idle), and these information are interrelated. According to this example of FIG. 14, the connection No. 003 is other than that established by executing a server cooperation function, and is now in the idle state.

If there exist in the connection administration table, any connections other than that established by executing a server cooperation function (YES in Step S59), then in Step S602, the connections other than that established by executing a server cooperation function are terminated, and specifically among those, an idle connection is preferentially terminated. In this connection administration table of FIG. 14, the connection No. 003 is preferentially terminated.

The connection forcibly terminated here may have a record of the longest connection time. This would minimize an adverse affect happening if a connection of the longest connection time is terminated, since it is recognized that the longer a connection time becomes, the larger amount of data has been transferred.

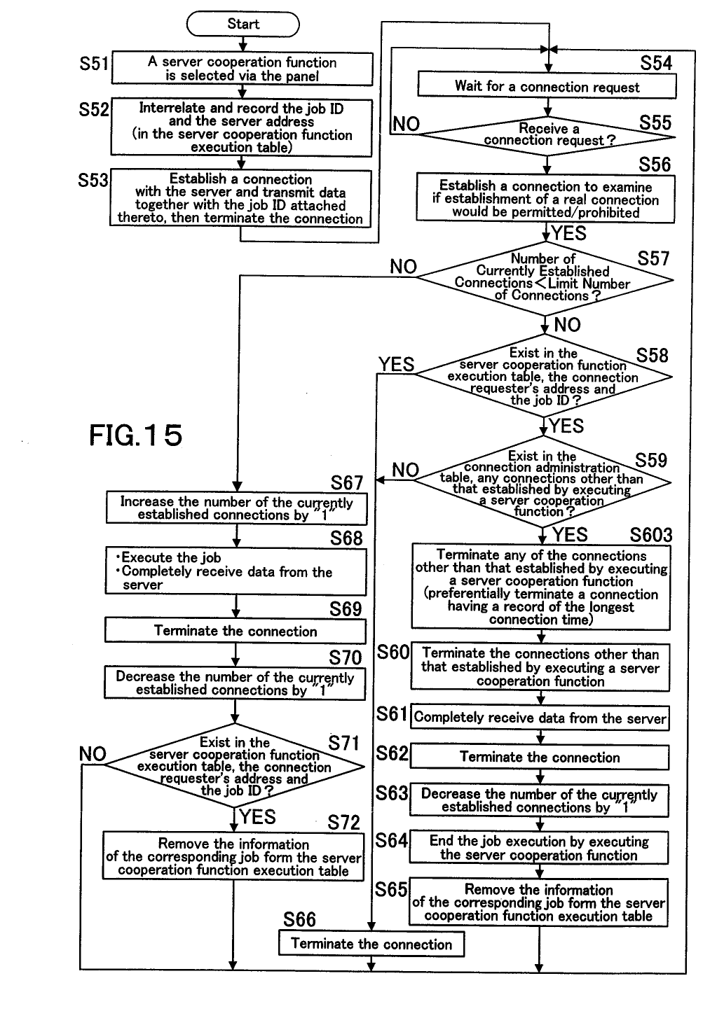

FIG. 15 is a flowchart showing a procedure executed by executing a server cooperation function, to preferentially terminate a connection having a record of the longest connection time, if a connection request is received from the server 2 and the number of concurrent connections owned by the image forming apparatus 1 reaches the limit number of connections. Explanation about some of the Steps of this flowchart, having the same Step numbers as those in FIG. 8, is omitted.

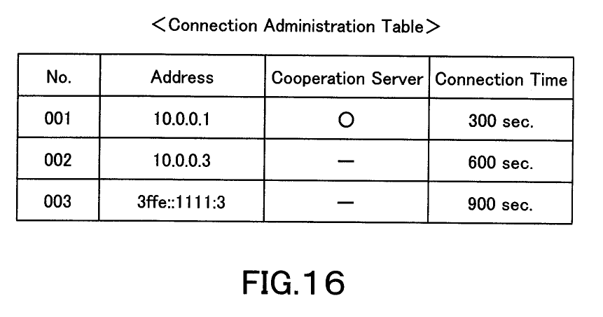

In Step S58, it is judged whether or not there exist in the server cooperation function execution table shown in FIG. 5, the connection requester's address and the job ID. If there exist in the server cooperation function execution table the connection requester's address and the job ID (YES in Step S58), then it is judged in Step S59, whether or not there exist in the connection administration table shown in FIG. 16, any connections other than that established by executing a server cooperation function.

The connection administration table shown in FIG. 16 records the destination apparatuses' addresses, information indicating whether or not the apparatuses correspond to servers that established the connections by executing a server cooperation function, and connection times, and these information are interrelated. According to this example of FIG. 16, the connection No. 003 is other than that established by executing a server cooperation function, and has a record of the longest connection time.

If there exist in the connection administration table, any connections other than that established by executing a server cooperation function (YES in Step S59), and then in Step S603, the connections other than that established by executing a server cooperation function are terminated, and specifically among those, a connection having a record of the longest connection time is preferentially terminated. In this connection administration table of FIG. 16, the connection No. 003 is preferentially terminated.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image forming apparatus that has a server cooperation function to transmit data to a data processing server connected therewith via a network and receive processed data after the server performs data processing, and is capable of communicating with a plurality of external apparatuses via the network by establishing concurrent connections, comprising:
a judger that judges whether or not the number of the currently established connections with the external apparatuses reaches a limit number of connections that is an allowable upper limit of concurrent connections, during execution of the server cooperation function; and
a controller that reserves a connection with the server if the judger judges that the number of the currently established connections does not reach the limit number of connections, and cancels the reserved connection after the end of the execution of the server cooperation function.

2. The image forming apparatus recited in claim 1, wherein the controller cancels the reserved connection, if the execution of the server cooperation function is not ended within a predetermined period of time after the start of the execution of the server cooperation function.

3. The image forming apparatus recited in claim 1, wherein the controller keeps going the execution of the server cooperation function until any of the currently established connections is terminated, if the judger judges that the number of the currently established connections reaches the limit number of connections.

4. The image forming apparatus recited in claim 1, wherein the maximum number of connections with the server, which are reserved to be established by executing the server cooperation function, is set to a value smaller than the limit number of connections.

5. An image forming apparatus that has a server cooperation function to transmit data to a data processing server connected therewith via a network and receive processed data after the server performs data processing, and is capable of communicating with a plurality of external apparatuses via the network by establishing concurrent connections, comprising:
a detector that detects a connection request that is transmitted by the server in order to transmit the processed data subsequently;
a judger that judges whether or not the number of the currently established connections with the external apparatuses reaches a limit number of connections that is an allowed upper limit of concurrent connections; and
a controller that terminates any of the currently established connections, if the detector detects a connection request from the server and the judger judges that the number of the currently established connections reaches the limit number of connections.

6. The image forming apparatus recited in claim 5, wherein the controller preferentially terminates a connection established by a user who instructed to execute the server cooperation function.

7. The image forming apparatus recited in claim 5, wherein the controller preferentially terminates an idle connection not currently used for data communication.

8. The image forming apparatus recited in claim 5, wherein the controller preferentially terminates a connection having the longest connection time.

9. A communication control method of an image forming apparatus that has a server cooperation function to transmit data to a data processing server connected therewith via a network and receive processed data after the server performs data processing, and is capable of communicating with a plurality of external apparatuses via the network by establishing concurrent connections, comprising:
judging whether or not the number of the currently established connections with the external apparatuses reaches a limit number of connections that is an allowable upper limit of concurrent connections, during execution of the server cooperation function; and
reserving a connection with the server if it is judged in the judgment step that the number of the currently established connections does not reach the limit number of connections, and cancelling the reserved connection after the end of the execution of the server cooperation function.

10. The communication control method of the image forming apparatus, recited in claim 9, wherein the reserved connection is cancelled, if the execution of the server cooperation function is not ended within a predetermined period of time after the start of the execution of the server cooperation function, in the reservation and cancellation step.

11. The communication control method of the image forming apparatus, recited in claim 9, wherein the execution of the server cooperation function is kept going until any of the currently established connections is terminated, if it is judged in the judgment step that the number of the currently established connections reaches the limit number of connections.

12. The communication control method of the image forming apparatus, recited in claim 9, wherein the maximum number of connections with the server, which are reserved to be established by executing the server cooperation function, is set to a value smaller than the limit number of connections.

13. A communication control method of an image forming apparatus that has a server cooperation function to transmit data to a data processing server connected therewith via a network and receive processed data after the server performs data processing, and is capable of communicating with a plurality of external apparatuses via the network by establishing concurrent connections, comprising:
detecting a connection request that is transmitted by the server in order to transmit the processed data subsequently;
judging whether or not the number of the currently established connections with the external apparatuses reaches a limit number of connections that is an allowable upper limit of concurrent connections;
terminating any of the currently established connections, if a connection request from the server is detected in the detection step and it is judged in the judgment step that the number of the currently established connections reaches the limit number of connections.

14. The communication control method of the image forming apparatus, recited in claim 13, wherein a connection established by a user who instructed to execute the server cooperation function is preferentially terminated in the connection termination step.

15. The communication control method of the image forming apparatus, recited in claim 13, wherein an idle connection not currently used for data communication is preferentially terminated in the connection termination step.

16. The communication control method of the image forming apparatus, recited in claim 13, wherein a connection having the longest connection time is preferentially terminated in the connection termination step.

17. A computer readable recording medium having a communication control program recorded therein to make a computer of an image forming apparatus that has a server cooperation function to transmit data to a data processing server connected therewith via a network and receive processed data after the server performs data processing, and is capable of communicating with a plurality of external apparatuses via the network by establishing concurrent connections, execute:
judging whether or not the number of the currently established connections with the external apparatuses reaches a limit number of connections that is an allowable upper limit of concurrent connections, during execution of the server cooperation function; and
reserving a connection with the server if it is judged in the judgment step that the number of the currently established connections does not reach the limit number of connections, and cancelling the reserved connection after the end of the execution of the server cooperation function.

18. A computer readable recording medium having a communication control program recorded therein to make a computer of an image forming apparatus that has a server cooperation function to transmit data to a data processing server connected therewith via a network and receive processed data after the server performs data processing, and is capable of communicating with a plurality of external apparatuses via the network by establishing concurrent connections, execute:
detecting a connection request that is transmitted by the server in order to transmit the processed data subsequently;
judging whether or not the number of the currently established connections with the external apparatuses reaches a limit number of connections that is an allowable upper limit of concurrent connections; and
terminating any of the currently established connections, if a connection request from the server is detected in the detection step and it is judged in the judgment step that the number of the currently established connections reaches the limit number of connections.
